(19) United States
(12) Patent Application Publication
(10) Pub. No.: US 2005/0193344 A1
(43) Pub. Date: Sep. 1, 2005

(54) Display device

(75) Inventor: Kazuo Miyaji, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/064,937

(22) Filed: Feb. 25, 2005

(30) Foreign Application Priority Data
Feb. 27, 2004 (JP) 2004-53914

(51) Int. Cl. G06F 3/00; G11B 27/00

(52) U.S. Cl. 715/722; 715/810; 715/712; 715/713; 715/778; 715/708

(57) ABSTRACT

According to the present invention, light of a color specified by the color data corresponding to the hierarchy level to which the selected attribute item belongs is emitted to the display unit. Users can thus recognize from this color, the hierarchy level of the attribute item displayed on the display unit. That is, without using an expensive display unit such as one that can display complicated images including diagrams as described in the conventional example, even an inexpensive display unit such as one that can provide character display of the attribute item allows users to recognize the hierarchy level only by an inexpensive light source capable of emitting a plurality of colors of light. Moreover, unlike the conventional example, it is no longer necessary to provide the display unit with an area for displaying a hierarchical structure, thereby preventing the display unit from increasing in size.

### BACKGROUND OF THE INVENTION

1. Field of the Invention

The present invention relates to a display device and, more particularly, to a device for displaying hierarchical items in various electronic apparatuses such as a printer.

2. Description of the Related Art

Recent electronic apparatuses offer a wide variety of functions and accordingly, settings which must be done in those apparatuses by users are also increasing. Lots of items are typically classified into different levels of a hierarchy; however, a complex hierarchical structure causes difficulties for users to operate. In particular, when a user gets confused about which level of the hierarchy he/she is making operations at, the user is required to return to the upper level of the hierarchy in order to move to and see other items, which makes operations complicated. To avoid such a problem, a display method disclosed in Japanese Patent Application Laid-open No. 2000-147018 makes it possible for users to visually recognize a hierarchy level they are currently operating at by diagrammatically indicating a menu structure.

### SUMMARY OF THE INVENTION

This display method disclosed in Japanese Patent Application Laid-open No. 2000-147018, however, has a disadvantage that a display device requires an area for displaying a hierarchical structure besides a menu indication area, thereby leading to an increase in size and cost of the display device. Although a menu screen and a hierarchical structure screen can alternatively be switched for display, users are forced to make extra operations in this case, which rather brings more complications. Furthermore, since it is necessary to indicate the menu structure, this display method disclosed in Japanese Patent Application Laid-open No. 2000-147018 is not applicable to an inexpensive character display LCD (Liquid Crystal Display). In consideration of such a problem, the present invention has an object to provide a display device which allows easy recognition of a structure of items even with an inexpensive character display LCD.

In order to achieve the object, according to a first aspect of the present invention, there is provided a display device comprising: a display unit; a light source which emits a plurality of colors of light to the display unit; a first storage unit which stores a plurality of attribute items classified into different levels of a hierarchy; a second storage unit which stores color data specifying a color of light emitted from the light source in relation to each of the levels in the hierarchy; a selection unit which accepts a selected desired attribute item by causing one of the plurality of attribute items to be selected from a top level of the hierarchy in a hierarchical descending order of levels; and a control unit which causes the display unit to display the selected attribute item in accordance with each of the levels in the hierarchy, wherein the control unit controls the light source so that the light source emits light of a color specified by the color data corresponding to a hierarchy level of the selected attribute item.

According to the first aspect, light of a color specified by the color data corresponding to the hierarchy level to which the selected attribute item belongs is emitted to the display unit. Users can thus recognize from this color, the hierarchy level of the attribute item displayed on the display unit. That is, without using an expensive display unit such as one that can display complicated images including diagrams as described in the conventional example, even an inexpensive display unit such as one that can provide character display of the attribute item (e.g., character display type LCD) allows users to recognize the hierarchy level only by an inexpensive light source (e.g., LED; Light-Emitting Diode) capable of emitting a plurality of colors of light. In addition, unlike the conventional example, it is not necessary to provide the display unit with an area for displaying the hierarchical structure, thereby preventing the display unit from increasing in size.

According to a second aspect of the present invention, in the display device of the first aspect, the first storage unit stores groups into which the attribute items in each of the levels in the hierarchy are classified, the second storage unit stores the color data in relation to each of the groups, and the control unit controls the light source so that the light source emits light of a color corresponding to a hierarchy level and group of the selected attribute item.

According to the second aspect, a color of light emitted from the light source is changed depending on a hierarchy level and group of the attribute item displayed on the display unit, which allows users to easily recognize the subordinate relationship of the hierarchy levels as well as the attribute items.

According to a third aspect of the present invention, in the display device of the first or second aspect, the light source is an LED backlight.

According to the third aspect, the display device of the present invention can be manufactured at low costs.

According to the present invention, light of a color specified by the color data corresponding to the hierarchy level to which the selected attribute item belongs is emitted to the display unit. Users can thus recognize from this color, the hierarchy level of the attribute item displayed on the display unit. That is, without using an expensive display unit such as one that can display complicated images including diagrams as described in the conventional example, even an inexpensive display unit such as one that can provide character display of the attribute item (e.g., character display type LCD) allows users to recognize the hierarchy level only by an inexpensive light source (e.g., LED) capable of emitting a plurality of colors of light. Moreover, unlike the conventional example, it is no longer necessary to provide the display unit with an area for displaying a hierarchical structure, thereby preventing the display unit from increasing in size.

### BRIEF DESCRIPTION OF THE DRAWINGS

FIG. 1 is a block diagram showing a configuration of a printer according to preferred embodiments of the present invention;

FIG. 2 is an external view of a display panel;

FIG. 3 is a diagram showing a plurality of attribute items classified into different levels of a hierarchy;

FIG. 4 is a flowchart showing a flow of display control processing; and

FIG. 5 is a diagram showing the plurality of attribute items classified into different levels and groups of a hierarchy.

### DETAILED DESCRIPTION OF THE PREFERRED EMBODIMENTS

Preferred embodiments of the present invention will be described below with reference to the accompanying drawings.

### First Embodiment

[Configuration Outline]

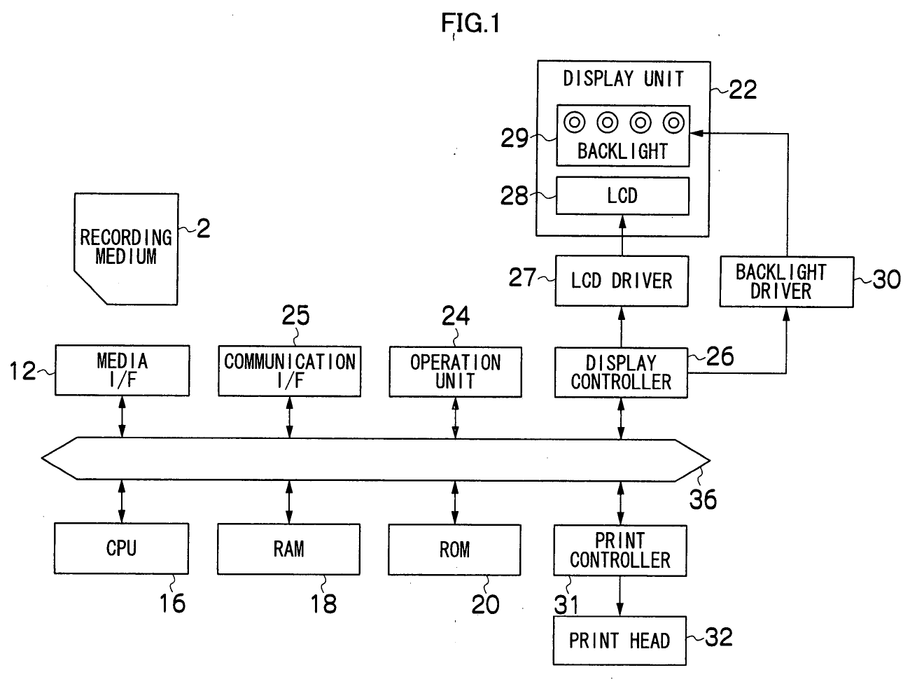

FIG. 1 is a block diagram showing a configuration of a printer according to the preferred embodiments of the present invention. This printer mainly comprises a media interface (I/F) 12 which reads data from a recording medium 2, a CPU 16, a RAM 18 used for temporal storage of various data, and a calculation area or the like, a ROM 20 in which is stored data and programs necessary for calculation, frames, and the like, a display unit 22 which includes an LCD 28 and a backlight 29, and displays various information, a display controller 26 which controls the display of the display unit 22, an LCD driver 27 which drives the LCD 28 in accordance with the control of the display controller 26, a backlight driver 30 which drives the backlight 29 in accordance with the control of the display controller 26, a communication interface 25 which can connect the printer with personal computers or other external devices, an operation unit 24 which accepts various operational inputs made by users, and a bus 36 which delivers signals between circuit blocks. The backlight 29 can, for example, be a light-emitting diode (LED) or a photoelectric tube, but any types of lighting equipment capable of generating colors are applicable to the backlight 29. The backlight 29 in the first embodiment is an LED backlight mounted with four chips of red (R), green (G), blue (B), and white (colorless, W) so as thereby to emit light of an arbitrary color (orange and yellow in this embodiment) by mixing the three primary colors (RGB).

In the recording medium 2, data of photo images taken by a user with a digital camera and the like is stored. The recording medium 2 includes various types of removable media such as SmartMedia (Solid-State Floppy Disk Card), PC card, CompactFlash™, magnetic disk, optical disk, magneto-optic disk, and memory stick. A signal processing unit and the media interface 12 that correspond to a medium used are provided. In order to support several types of the recording medium 2, it is also preferable to provide several types of the media interface 12.

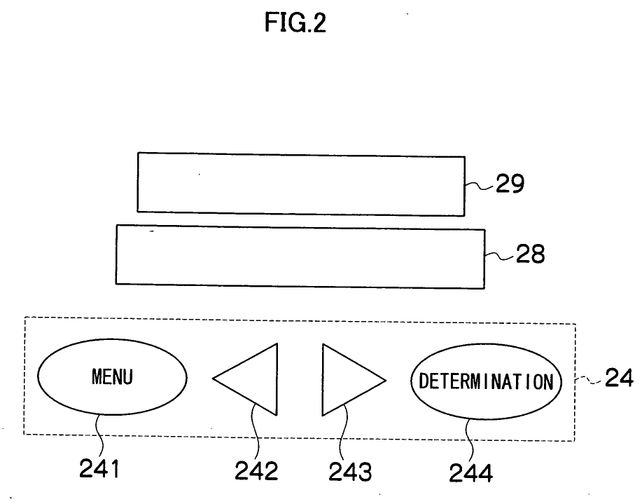

As shown in FIG. 2, the LCD 28, backlight 29, and operation unit 24 are integrally disposed as an operational panel at a position easily operable and recognizable by users, such as at a front face of the printer. The backlight 29 is disposed at a position such that it can impart an arbitrary color to displayed contents of the LCD 28 by emitting light of R, G, B, or W from the back of the LCD 28. The LCD 28 is functional enough if having a character display capability of, for example, displaying 16 characters per line, and it may not have a capability of displaying images other than characters. The operation unit 24 has a menu button 241, selection buttons 242 and 243, and a determination button 244. Users select the attribute item displayed on the LCD 28 by the selection buttons 242 and 243 of the operation unit 24, and determine the selected attribute item by the determination button 244. Details of the attribute items will be described later.

Referring back to FIG. 1, the CPU 16 and a print controller 31 are connected with each other via the bus 36 so that control signals and image data are transferred between the CPU 16 and print controller 31. The RAM 18 stores setting items input from the operation unit 24, and the CPU 16 generates image data for print output in accordance with the setting items stored in the RAM 18 and the image data recorded in the recording medium 2. In the first embodiment, the setting items mean items to be set regarding various functions of the printer (e.g., print paper size, background image of the print paper, and the type of the recording medium from which the image data is taken).

The image data for print output is sent to the print controller 31 by which the image data is converted to control signals for driving a print head 32. The print head 32 is thereby controlled and printing operation is carried out, and as a result of output of the printer, a printed matter is obtained. A printing method is not particularly limited, and various methods are applicable including a thermo-autochrome™ (TA) printing method in which a print paper itself generates its own colors when heated, or an ink jet printing method in which ink droplets are ejected from a nozzle to a print paper.

The ROM 20 stores a program, and the CPU 16 loads the program onto the RAM 18 to execute process steps described therein. The RAM 18 is used as a work memory when the CPU 16 executes the program.

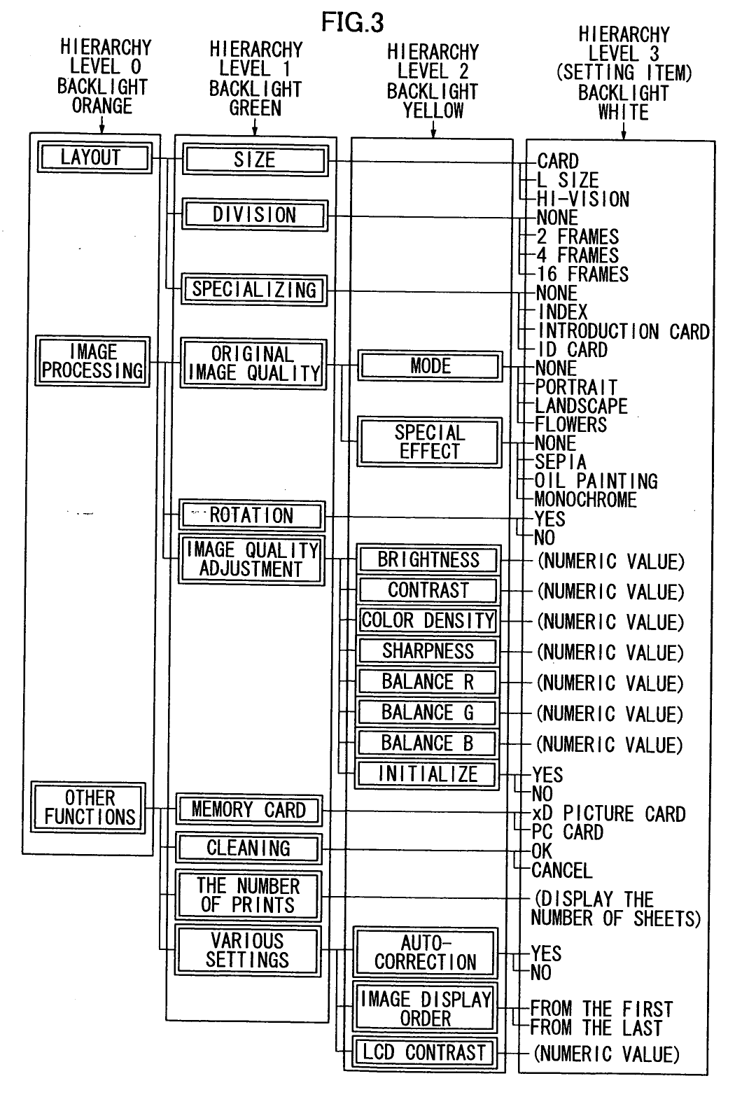

Furthermore, the ROM 20 stores a plurality of attribute items classified into different levels of a hierarchy. FIG. 3 is an example of the attribute items which are classified into different levels of a hierarchy and stored in the ROM 20. According to FIG. 3, each attribute item belongs to one of four levels of the hierarchy from a hierarchy level 0 at the top of the hierarchy to a hierarchy level 3 at the bottom of the hierarchy, and all attribute items which belong to the levels except for the hierarchy level 0 are subordinate to one of the attribute items in the upper level. The attribute items in the level 3 at the bottom of the hierarchy correspond to the setting items. The level 0 at the top of the hierarchy includes the attribute items of “layout”, “image processing”, and “other functions”. Each of the attribute items in the hierarchy level 1 which is one level lower than the hierarchy level 0 is subordinate to one of the attribute items in the hierarchy level 0. For example, the attribute items of “size”, “division”, and “specializing” in the hierarchy level 1 are subordinate to the attribute item “layout” in the hierarchy level 0. In addition, the setting items of “card”, “L size”, and “Hi-Vision” in the level 3 at the bottom of the hierarchy are subordinate to the attribute item “size” in the hierarchy level 1. Moreover, the setting items of “from the first” and “from the last” in the level 3 at the bottom of the hierarchy are subordinate to the attribute item “image display order” in the hierarchy level 2. Thus, the attribute items in the levels except for the hierarchy level 0 are subordinate to one of the attribute items that are one or more levels upper in the hierarchy.

The ROM 20 further stores, in relation to each level of the hierarchy, color data that specifies a color to be generated by the backlight 29. As shown in FIG. 3, the hierarchy levels 0, 1, 2, and 3 are associated with four pieces of color data for generating orange, green, yellow, and white, respectively, by the backlight 29.

[Display Control Processing]

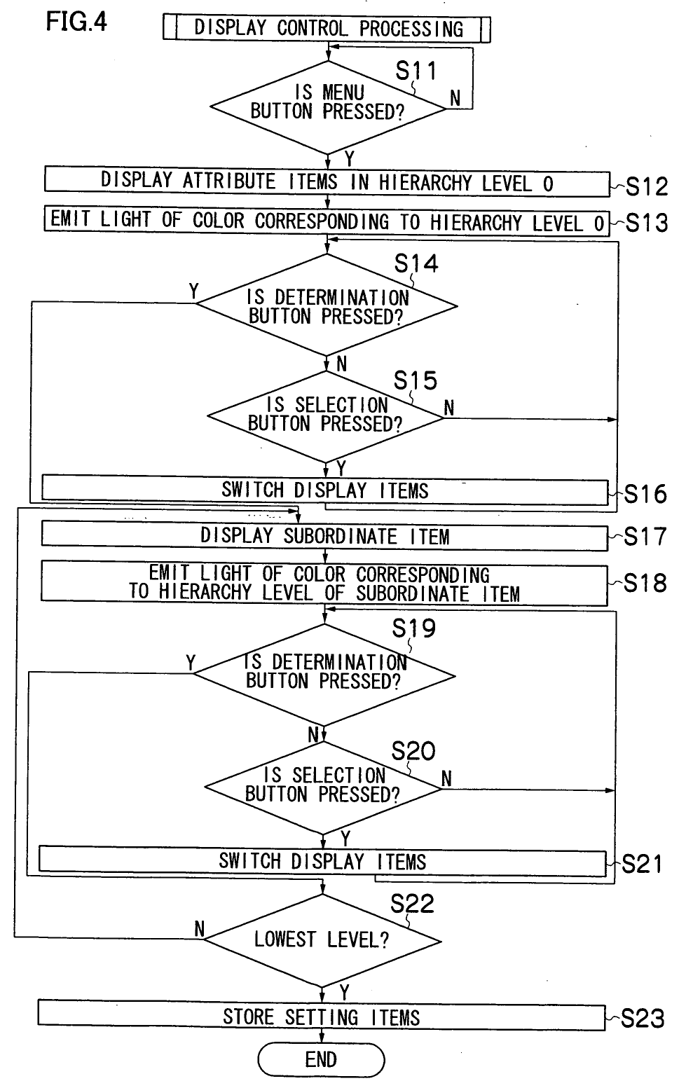

Referring next to the flowchart in FIG. 4, a description will be given of display control processing executed for the display unit 22 by the CPU 16 and display controller 26. In step S11, determination is made as to whether the menu button 241 is pressed. When the menu button 241 is pressed, the processing proceeds to step S12, and when is not pressed, the pressing operation is waited. In step S12, one of the attribute items in hierarchy the level 0 is displayed on the LCD 28 in a controlled manner. In step S13, the color data corresponding to the hierarchy level 0 is read from the ROM 20, and light of a color specified by the color data is emitted from the backlight 29 in a controlled manner.

In step S14, determination is made as to whether the determination button 244 is pressed. When the determination button 244 is pressed, the processing proceeds to step S17, and when is not pressed, the processing proceeds to step S15. In step S15, determination is made as to whether the selection button 242 or 243 is pressed. When the selection button 242 or 243 is pressed, the processing proceeds to step S16, and when is not pressed, the processing returns to step S14. In step S16, control is made so that the attribute items to be indicated on the LCD 28 are switchably displayed thereon within the bounds of the hierarchy level 0 in accordance with the number of pressing operations of the selection buttons 242 and 243.

In step S17, one of the attribute items directly subordinate (referred to as subordinate item, hereinbelow) to the attribute item currently displayed on the LCD 28 is displayed thereon. In step S18, the color data corresponding to the hierarchy level to which the displayed subordinate item belongs is read from the ROM 20, and then light of a color specified by the color data is emitted from the backlight 29.

In step S19, determination is made as to whether the determination button 244 is pressed. When the determination button 244 is pressed, the processing proceeds to step S22, and when is not pressed, the processing proceeds to step S20. In step S20, determination is made as to the selection button 242 or 243 is pressed. When the selection button 242 or 243 is pressed, the processing proceeds to step S21, and when is not pressed, the processing returns to step S19. In step S21, control is made so that the attribute items to be indicated on the LCD 28 are switchably displayed thereon within the bounds of the subordinate items in accordance with the number of pressing operations of the selection buttons 242 and 243.

In step S22, determination is made as to whether the attribute item currently displayed on the LCD 28 belongs to the lowest level of the hierarchy (the hierarchy level 3 in this case) stored in the ROM 20. When the attribute item belongs to the lowest level of the hierarchy, the processing proceeds to step S23. When the level of the attribute item is not the lowest level of the hierarchy, the processing returns to step S17 in which one of attribute items directly subordinate to the currently displayed attribute item is indicated again on the LCD 28 as similarly mentioned above, and the color data corresponding to the hierarchy level of the displayed attribute item is read from the ROM 20, so that light of a color specified by the color data is emitted from the backlight 29. When the menu button 241 is pressed while the processing steps from S17 to S22 are executed, the attribute item to which the currently displayed subordinate item is subordinate is indicated on the LCD 28, and light of a color corresponding to the hierarchy level of the indicated attribute item is emitted from the backlight 29. In step S23, the currently displayed setting items are stored in the RAM 18. The setting items may be designated by, as described above, selecting the attribute item with the selection buttons 242 and 243 and then pressing the determination button 244, or as an alternative configuration, the setting items may be determined by designating numeric values. In this case, an input of the numeric values is accepted through operations of a ten key (not shown) that is included in the operation unit 24, and when the determination button is pressed after the input of the numeric values, the input numeric values are stored as the setting items.

Note here that the ROM 20 stores a program for causing the CPU 16 and the display controller 26 to execute the above processing steps S11 through S23.

As described above, light of a color corresponding to the hierarchy level to which the attribute item displayed on the LCD 28 belongs is emitted from the backlight 29 to the LCD 28, which allows users to recognize, from the color of light, the hierarchy level of the attribute item currently displayed on the LCD 28. That is, even when the level of the attribute item is low in the hierarchy, users can easily recognize which level they are operating at in accordance with the color of the backlight 29, and user's unnecessary operations can be eliminated such as returning to an upper level of the hierarchy because they are confused about where they are. Furthermore, unlike the conventional example, the LCD 28 may not be provided with an area for displaying a hierarchical structure, and thus it is no longer necessary to use an expensive display unit such as one that can display complicated images such as a diagram. Therefore, the inexpensive LCD 28 that can display the attribute items by characters is functional enough for a display unit, leading to the prevention of increasing size of the display area. Also, an operation manual of the printer would be easy to read if instruction descriptions of the attribute items are applied with the same colors as those generated by the backlight 29 so as to maintain the correspondence between the hierarchy levels and the colors of light.

### Second Embodiment

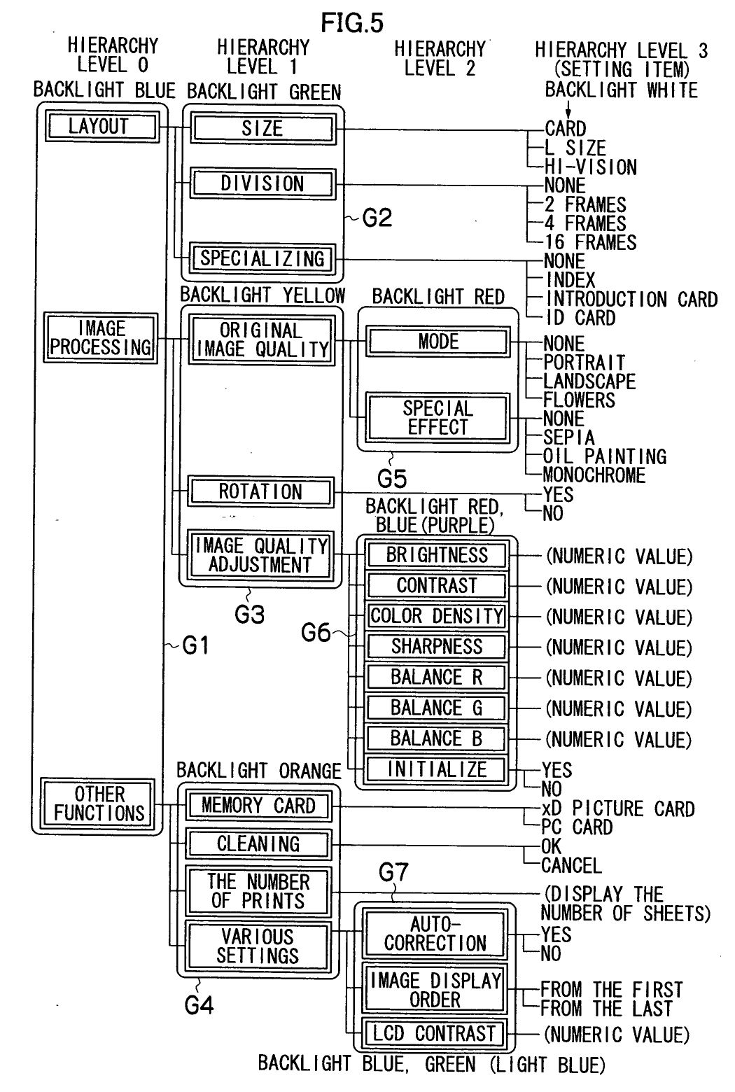

In the first embodiment, the ROM 20 stores a plurality of the attribute items classified into different levels of the hierarchy. It is, however, also allowable to classify a set of subordinate items directly subordinate to one attribute item into the same group and to store every group of attribute items in relation to the corresponding color data. For example, as shown in FIG. 5, “size”, “division”, and “specializing” that are subordinate items of “layout” are classified into a group G2. The attribute items in the hierarchy level 0 are not subordinate items, but are classified into a group G1 for convenience. Each of the groups G1 to G7 for thus classified attribute items is stored in relation to the color data. For example, the group G1 and group G2 are stored in relation to the color data for generating blue and green, respectively.

The display control processing executed by the CPU 16 and display controller 26 is different from that in the first embodiment in the following point. That is, when the determination button 244 is pressed (“Y” in step S16), one of the subordinate items of the currently indicated attribute item is displayed on the LCD 28 (S17), and the color data corresponding to a group into which the subordinate item is classified is read from the ROM 20 to cause the backlight 29 to emit light of a color specified by the color data (S18). Other processing steps are the same as those in the first embodiment.

According to the foregoing control, a color of light emitted from the backlight 29 is changed depending on a hierarchy level and group of the attribute item displayed on the LCD 28, which allows users to easily recognize the subordinate relationship of the hierarchy levels as well as the attribute items.

### Other Embodiments

A method of emitting light of an arbitrary color to the LCD 28 is not limited to a backlight method of emitting light from the back as previously described, and it is also possible to employ a method of emitting light from the front of the LCD 28 and reflecting the emitted light by the back face of the LCD 28 (a reflection method). Furthermore, the present invention can be applied for controlling the display not only of setting items of a printer as in the foregoing description but also of various menu items classified into a hierarchy of levels in a digital camera or other electronic devices.

1. A display device, comprising:
a display unit;
a light source which emits a plurality of colors of light to the display unit;
a first storage unit which stores a plurality of attribute items classified into different levels of a hierarchy;
a second storage unit which stores color data specifying a color of the light emitted from the light source in relation to each of the levels in the hierarchy;
a selection unit which accepts a selected desired attribute item by causing one of the plurality of attribute items to be selected from a top level of the hierarchy in a hierarchical descending order of levels; and
a control unit which causes the display unit to display the selected attribute item in accordance with each of the levels in the hierarchy, wherein
the control unit controls the light source so that the light source emits light of a color specified by the color data corresponding to a hierarchy level of the selected attribute item.

2. The display device according to claim 1, wherein
the first storage unit stores groups into which the attribute items in each of the levels in the hierarchy are classified,
the second storage unit stores the color data in relation to each of the groups, and
the control unit controls the light source so that the light source emits light of a color corresponding to a hierarchy level and group of the selected attribute item.

3. The display device according to claim 1, wherein the light source is an LED backlight.

4. The display device according to claim 2, wherein the light source is an LED backlight.
